(19) United States
(12) Patent Application Publication
(10) Pub. No.: US 2023/0350812 A1
(43) Pub. Date: Nov. 2, 2023

(54) ARCHITECTURAL INTERFACE FOR ADDRESS TRANSLATION CACHE (ATC) IN XPU TO SUBMIT COMMAND DIRECTLY TO GUEST SOFTWARE

(71) Applicants: Philip Lantz, Cornelius, OR (US); Rupin H. Vakharwala, Hillsboro, OR (US)

(72) Inventors: Philip Lantz, Cornelius, OR (US); Rupin H. Vakharwala, Hillsboro, OR (US)

(21) Appl. No.: 18/344,042

(22) Filed: Jun. 29, 2023

(51) Int. Cl. G06F 12/1045

(52) U.S. Cl. CPC G06F 12/1045; G06F 2212/60

(57) ABSTRACT

In one embodiment, an apparatus comprises: at least one accelerator to perform operations on data; and an address translation cache (ATC) coupled to the at least one accelerator, the ATC to store address translations. The ATC is to: send a command to a pending request queue (PRQ) stored in a memory coupled to the apparatus, the PRQ associated with a process of a guest software; and send an interrupt to inform the process regarding the command. Other embodiments are described and claimed.

### BACKGROUND

There has been increased adoption of devices that support the Address Translation Service (ATS) of a Peripheral Component Interconnect Express (PCIe) architecture. More specifically, according to the PCIe Base Specification version 5.0 (2019), ATS provides a set of transactions for PCIe components to exchange and use translated addresses in support of native input/output (I/O) virtualization. However, inefficiencies still exist.

### BRIEF DESCRIPTION OF THE DRAWINGS

FIG. 1 is a diagram showing a shared virtual memory (SVM) and PCIe ATS, in accordance with various embodiments.

FIG. 2 is a block diagram of a portion of a system in accordance with an embodiment.

FIG. 3 is another block diagram of a portion of a system in accordance with an embodiment.

FIG. 4 is a flow diagram of a method in accordance with an embodiment.

FIG. 5 is a flow diagram of a method in accordance with another embodiment.

FIG. 6 is an embodiment of a fabric composed of point-to-point links that interconnect a set of components.

FIG. 7 is a block diagram of a system in accordance with another embodiment.

FIG. 8 is a block diagram of a system in accordance with another embodiment.

### DETAILED DESCRIPTION

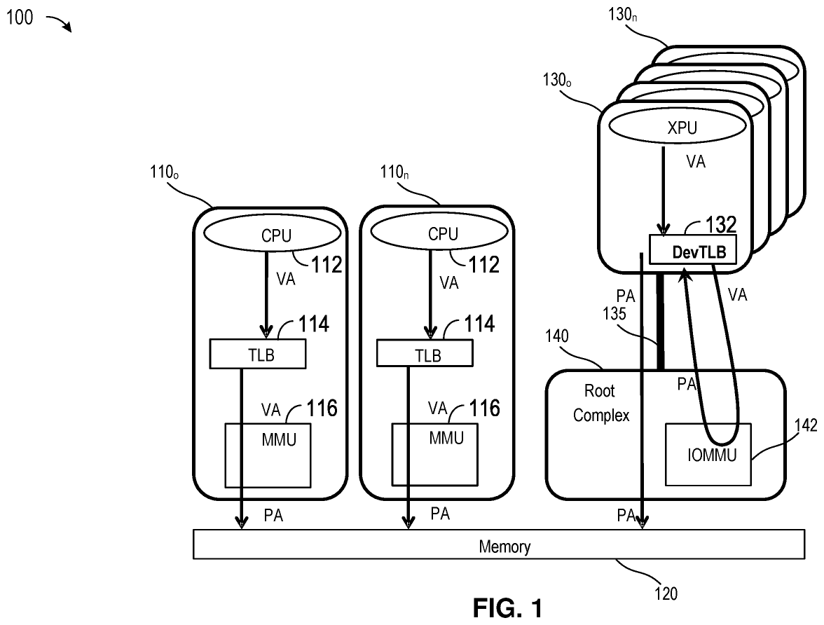

FIG. 1 is a diagram showing a shared virtual memory (SVM) and PCIe ATS, in accordance with various embodiments. Legacy computers are heterogenous systems that combine general purpose central processing units (CPUs) with specialized processing units (referred to herein as “XPUs”). Such systems are beginning to support SVM, where applications running on CPUs submit work to XPUs using virtual addresses, and expect that XPUs will be able to manipulate memory using virtual addresses just like the CPU. Using the page tables setup by Virtual Machines (VMs) and Virtual Machine Monitors (VMMs), memory management units (MMUs) translate Virtual Addresses (VA) into Physical Addresses (PA) for CPUs, and IOMMUs translate Virtual Addresses into Physical Addresses for XPUs as shown in FIG. 1. SVM allows CPUs and XPUs to manipulate complex data structures (e.g., trees) in memory without needless data copying. SVM also enables XPUs to handle page-faults, removing the requirement for XPUs to pin their memory, and thereby, for example, have a much larger working set size.

In the embodiment of FIG. 1, a computer system 100 may be any type of computing platform, ranging from small portable devices such as smartphones, tablet computers and so forth to larger devices such as client systems, e.g., desktop systems, server systems and so forth. As shown, system 100 includes a plurality of CPUs 110₀-110ₙ. CPUs 110 communicate with a memory 120, which may be implemented as a SVM that is further shared with a set of devices 130₀-130ₙ. Although shown generically in FIG. 1 as XPUs, understand that many different types of devices such as various PCIe or other such devices may be present in a given system. As further shown, a root complex 140 provides an interface between memory 120 and XPUs 130.

As illustrated in the high level of FIG. 1, CPUs 110 may include a processor complex (generally 112) which may include one or more cores or other processing engines. As seen, software that executes on these processing units may output VAs that may be provided to a translation lookaside buffer (TLB) 114. In general, TLBs 114 may buffer VA-to-PA addresses and potentially additional information. Such cache capability may be on behalf of a memory management unit (MMU) 116, which may include a greater set of address translations by way of a multi-level page table structure. In addition, MMU 116 may further include page miss handling circuitry to obtain address translations, e.g., from memory 120 when not present.

Similarly, root complex 140 includes another MMU, namely an IOMMU 142, that may store address translations on behalf of XPUs 130. Thus as shown, requests for translation may be received in root complex 140 from given XPUs 130 and in turn IOMMU 142 provides a physical address. Such translations may be stored in a TLB within XPU 130, referred to as a device TLB or more particularly herein, an address translation cache (ATC) 132. Then, with this physical address an XPU can send a memory request (e.g., read or write) to memory 120 with a given physical address. Note that in different implementations, root complex 140 may be a separate component or can be present in an SoC with a given one or more CPUs.

In different embodiments, an interconnect 135 that couples XPUs 130 to root complex 140 may provide communication according to one or more communication protocols such as PCIe, Compute Express Link (CXL) (such as a CXL.io protocol) or an integrated on-chip scalable fabric (IOSF), as examples.

With an arrangement as in FIG. 1, certain communications between a guest software and an ATC may avoid “middle agents” such as IOMMU hardware and host software. However without an embodiment, commands from an ATC to a guest software may still involve these middle agents. Embodiments thus improve performance and scalability by removing these middle agents from command communications between an ATC and guest software.

To this end, a translation agent (e.g., an IOMMU) may be configured to describe guest-specific command queues (which can be a page request queue or more generally a pending request queue (both termed “PRQ”) to receive commands from ATCs, via a so-called PRQ descriptor. In turn, the ATC is configured with an interface to obtain the location/property of such PRQs and thereafter provide guest software-directed commands directly to these PRQs and inform the guest software of their presence. Thus with embodiments, an ATC is configured to allow it to send commands (e.g., page faults) to an appropriate guest queue and then inform the relevant guest software as to presence of such commands.

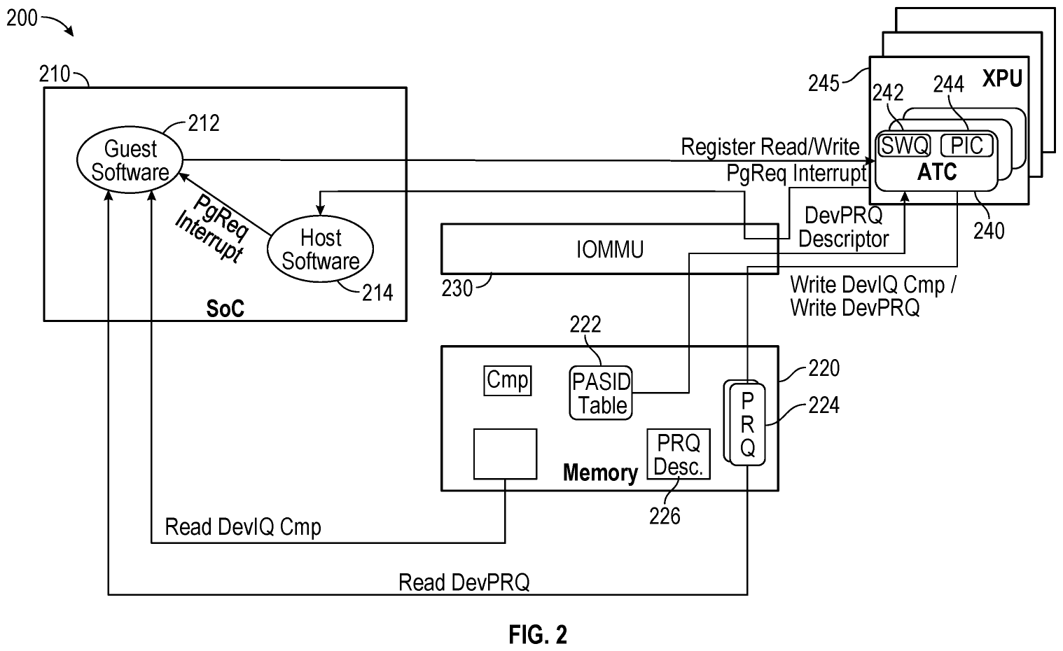

Referring now to FIG. 2, shown is a block diagram of a portion of a system in accordance with an embodiment. In FIG. 2 system 200 may be any type of computing platform having a SoC 210 or other CPU (and which may include multiple cores). As shown, a guest software 212 (e.g., a VM) interacts with a host software 214 (e.g., VMM). Also present in system 200 is a plurality of XPUs 245, each of which includes an ATC 240. Both SoC 210 and XPUs 245 may share a memory 220, which acts as a SVM. Translation from Virtual to Physical (and Guest to Host) may be implemented at least in part using a translation agent, illustrated as IOMMU 230.

As further illustrated in FIG. 2, an architectural interface is provided to enable an ATC to send commands directly to guest software. To this end, embodiments provide a process address space identifier (PASID) table 222 within memory 220. PASID table 222 contains a Guest PASID associated with a Host PASID and also an address in memory where a PRQ descriptor is located. In this way, ATC 240 has ready access to guest PASIDs that can be used to directly provide commands (such as page requests) to guest software 212. To this end, ATC 240 may write such commands to PRQ 224, e.g., using a PRQ descriptor address for a PRQ descriptor 226.

In turn, ATC 240 informs guest software 212, e.g., via an interrupt, to indicate presence of one or more commands within PRQ 224. Note that this interrupt is not sent every time a command is written into PRQ 224; instead, an interrupt is sent only when guest software 212 has requested the interrupt, e.g., by setting of a bit within PRQ descriptor 226, details of which will be described further below.

With this arrangement, embodiments provide an efficient interface to allow an ATC to directly communicate with guest software, without involvement of host software. As such, improved processing efficiency is realized, as virtual machine exits to guest software can be avoided, along with the concomitant host processing of such incoming requests from an ATC.

To this end (reducing middle agents), embodiments provide a Translation Agent (TA) architecture to describe guest-specific command queues to directly receive commands from ATCs. In addition, an ATC in accordance with an embodiment is configured to request location/property of such guest-specific command queues from TA. In addition, the ATC is configured to send commands (e.g., page faults) to an appropriate guest queue and then inform the relevant guest software in a manner that reduces interaction with middle agents.

In FIG. 2, host software 214 provides TA 230 with a mapping structure that contains properties of a process for which TA 230 performs address translation. With embodiments, host software 214 includes a PRQ-descriptor-address field in each process's mapping structure entry. Guest software 212 programs the PRQ-descriptor with location/head-pointer/tail-pointer and a few other fields to describe the queue. In turn ATC 240 may, via a ProcessInfoRequest, request the PRQ-descriptor-address from TA 230 and cache it, e.g., in a ProcessInfoCache (PIC) 244. Then, when ATC 240 seeks to send a command to a process, it uses the PRQ-descriptor-address (e.g., stored in the PIC) to read the properties of the PRQ, send a write to the location pointed to by PRQ-tail and send an interrupt to the process to inform it that there is a command for it to process. Since the command queues are stored in guest memory, they scale with number of Guests and number of processes without any impact to TA hardware.

The ATS specification supports an ATC-IOMMU interface, to allow an XPU to request address translations from the IOMMU and cache the results in the ATC. Thereafter, the ATC uses the results stored in the ATC to send a translated request to access memory. A system software-ATC interface allows system software to issue invalidations to the ATC to remove stale translations from the ATC. With embodiments, an ATC can send commands to guest software using simple memory writes. There is no impact to an XPU driver or XPU-driver/OS interface as the command queues are in guest memory. An ATC-system software interface allows an XPU-ATC to report page faults to system software and can be extended to allow XPU-ATC to send other commands to system software.

With embodiments, a higher performance interface is realized, as the ATC can send commands to guest software directly without TA or host software acting as middle agents (other than initialization).

As shown in FIG. 2, host software 214 programs the address of guest command queue 224 (called a PRQ-descriptor, or more generically a “descriptor”) in an IOMMU mapping structure (e.g., PASID table 222). IOMMU 230 in turn provides the PRQ-descriptor address to ATC 240, to enable it to write commands to the PRQ. ATC 240 then informs guest software 212 to read PRQ 224, e.g., by sending an interrupt. In one or more embodiments, the interrupt is not sent every time a command is written into PRQ 224, but only when a command is written into it and guest software 212 has asked for an interrupt using an indicator in PRQ descriptor 226.

In embodiments, each guest creates a queue (e.g., a circular queue) in memory with head/tail pointers to receive commands from the ATC. In examples described herein, this queue is a PRQ. For every PRQ, a guest creates a PRQ-descriptor that contains: the base of the queue; the current value of the head-pointer; the current value of the tail-pointer; a Pending Page Request (PPR) interrupt status; and a size of the queue.

Since a guest may send work from a given process (identified by PASID) to more than one XPU, there may be more than one ATC that may need to send commands to the guest. Thus, a guest can create a PRQ for every XPU/process pair that may be running. In an embodiment, the XPU is identified by PCIe Bus/Device/Function (BDF) and process is identified by PASID. The TA maintains process specific information in a PASID table as a mapping structure in a particular embodiment. More specifically, a TA may store mapping information per BDF, so there is a PASID-table entry for BDFx/PASIDi pair and a different PASID-table entry for BDFy/PASIDi pair. In contrast, without an embodiment, if a guest created a single PRQ to receive commands from all ATCs using PASIDi, then there would be multiple ATCs that would be trying to write into the queue simultaneously, which would require them to use atomic operations to insert command into PRQ resulting in unsatisfactory performance.

The guest provides the location of PRQ-descriptor to the host to cause it to program the location in an appropriate PASID-table entry as the PRQ-descriptor-address field. Additionally, the host adds the PASIDj that is associated with the guest in the PASID-table entry so that it can be sent with PRQ-descriptor-address to the XPU. The XPU uses PASIDj to access the PRQ-descriptor and PRQ. To effect this guest XPU/PASID combination, a PASID-table entry may include, inter alia, the following fields: PRQ-descriptor-address; PASIDj (host-PASID associated with the guest); PASIDj_valid (so host can specify if the XPU should access PRQ-descriptor and PRQ without PASID); and PRQ-interrupt-index.

As discussed above, the ATC requests the IOMMU to provide a location of a PRQ. In many implementations, it is not practical for an XPU to implement a large number of registers to describe every PRQ that may be used by the XPU (number of PRQ used by XPU=number of PASIDs running across all VMs that may use the XPU). As such, the XPU can request PRQ information from a TA when it seeks to use the PRQ. In an embodiment, the ATC can request PRQ-descriptor-address and the PASIDj associated with guest (both stored in PASID-table entry) from the TA using a ProcesslnfoRequest interface.

When an ATC receives a completion from the TA (in response to a translation request it sent earlier) with insufficient permissions, it considers that event as a page-fault. As a result, the ATC requests system software to provide the desired permission by sending a page-request to software, which is one example of a command that the ATC sends to system software.

It can be assumed that the Translation Completion informs the ATC that the page-fault is in the guest page-tables. With an embodiment, since software knows the BDF/PASID associated with each PRQ, commands themselves need not carry BDF/PASID information, eliminating complexity involved with mapping host-BDF (used by ATC) into guest-BDF (required by guest software) and mapping host-PASID (used by ATC) into guest-PASID (required by guest software).

Table 1 is an implementation of information included in a Page Request in accordance with an embodiment. Note there is no need to provide a PASID as part of this page request.

TABLE 1

| Field | | Field Width |
|---|---|---|
| Name | Field Description | (number of bits) |
| Command | Type of command being sent | 5 |
| | to software | |
| Page | Address of the Page for | 52 |
| Address | which ATC found insufficient | |
| | permission | |
| Page | This field contains ATC | 9 |
| Group | supplied identifier for the | |
| Index | associated page request. | |
| Read | This field, when Set, | 1 |
| Access | indicates that the ATC is | |
| Requested | requesting read access to the | |
| | associated page. | |
| Write | This field, when Set, | 1 |
| Access | indicates that the ATC is | |
| Requested | requesting read access to the | |
| | associated page. | |
| Last | This field, when Set, | 1 |
| Request in | indicates that the associated | |
| PRG | page request is the last | |
| | request of the associated | |
| | PRG. | |
| Privilege | This field, when Set, | 1 |
| | indicates that ATC is | |
| | requesting permission for | |
| | supervisory entity. When | |
| | Clear, ATC is requesting | |
| | permission for user entity. | |

When the ATC has a command to send to a guest, it obtains the PRQ-descriptor-address from the PIC and reads the PRQ-descriptor from memory using the PASIDj associated with the guest (obtained from PIC) to obtain the latest values of all fields that describe the PRQ. The ATC then generates a memory write transaction to the PRQ at the address PRQ-base+PRQ-tail. This memory write is performed using PASIDj, in an embodiment, which includes command information as described above in Table 1 as a payload of the memory write. After writing the command to the PRQ, the ATC generates a memory write to update the value of PRQ-tail at the address PRQ-descriptor-address+tail-offset using PASIDj. This memory write to update the PRQ-tail pushes ahead of it the memory write that puts the command into PRQ. Along with updating the PRQ-tail, the ATC also sets the PPR bit in PRQ-descriptor. When generating the command, if the ATC observes that the PRQ is full, it may stall the XPU and wait for space to be available in PRQ.

In certain embodiments, it can be assumed that the guest uses pinned memory for the PRQ and attempts by the ATC to write into the PRQ do not run into page-faults. However, in another embodiment the guest may use paged memory for the PRQ, and if the ATC encounters page-faults on a PRQ write, it would report such page-faults in a centralized PRQ in host memory using a Page Request Services as described by ATS 1.x specification. In such implementation, the ATC may stall the XPU to prevent the need to send additional commands to PRQ until the page-fault is resolved and the current command is written into the associated PRQ.

The ATC may inform guest software to look at the PRQ by sending an interrupt. As discussed above, the interrupt is not sent every time a command is written into the PRQ, but only when the PPR bit in PRQ-descriptor is found to be clear. Because the guest may have created many PRQs (one for each BDF/PASID pair), the ATC may generate a unique interrupt associated with the PRQ when it writes a command into the PRQ. To this end, the ProcesslnfoRequest that brought the PRQ-descriptor-address to ATC may also provide a PRQ-interrupt-index from the TA, which the ATC uses to index into its bank of MSI-X registers to find the correct interrupt to send to the CPU.

On receiving the interrupt from ATC, the guest software performs the following steps: (i) clear the PPR field in the PRQ-descriptor (so that the ATC may generate a new interrupt if it were to add more commands to PRQ); (ii) read the PRQ-descriptor (to get the latest value of Tail); (iii) read one or more commands from the PRQ between Head and Tail; and (iv) update the Head field in PRQ-descriptor.

Note that steps iii and iv may be done iteratively, updating Head after each command or group of commands is read from PRQ; or they may be done once, reading all the commands between Head and Tail at one time and updating Head one time.

To effect an architectural interface in accordance with an embodiment, guest software may perform various operations to set up a PRQ descriptor and populate it with information that can then be used to enable the ATC to use information in this PRQ descriptor to directly write commands into a PRQ and inform the guest software regarding the presence of such commands.

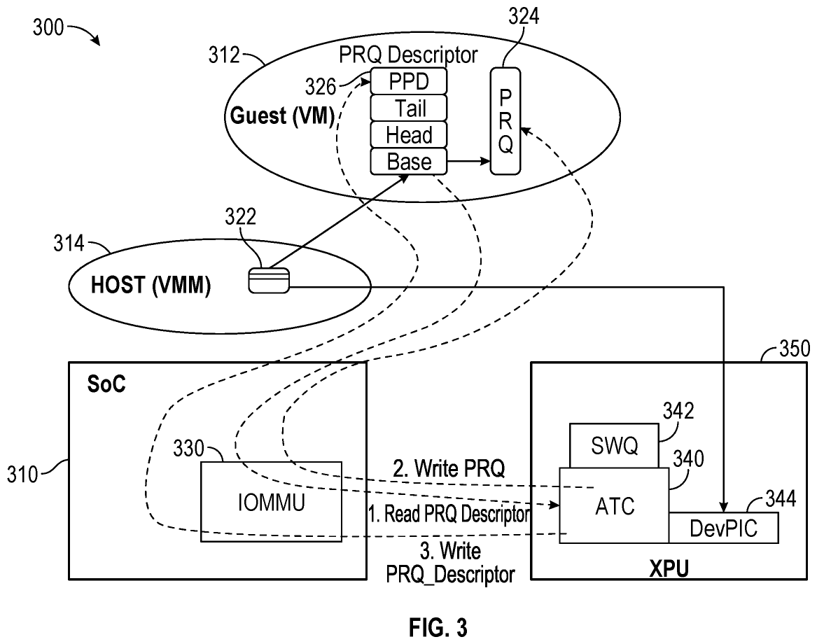

FIG. 3 is a further block diagram of a system in accordance with an embodiment. In FIG. 3, system 300 is implemented similarly to system 200 of FIG. 2 (with the same reference numerals, albeit of the “300” series), and further illustrates interaction between guest and host software and an ATC in accordance with an embodiment.

As shown, a location of a PRQ descriptor 326 (that includes information for an associated PRQ 324) is stored in an entry in a PASID table 322. The location of PRQ descriptor 326 is stored in DevPIC 344. Then when ATC 340 seeks to write a command to guest software 312, it first reads information of PRQ descriptor 326. Then it writes the command to the indicated location (using tail pointer information) within PRQ 324. Finally, ATC 340 updates the tail pointer via a write to PRQ descriptor 326.

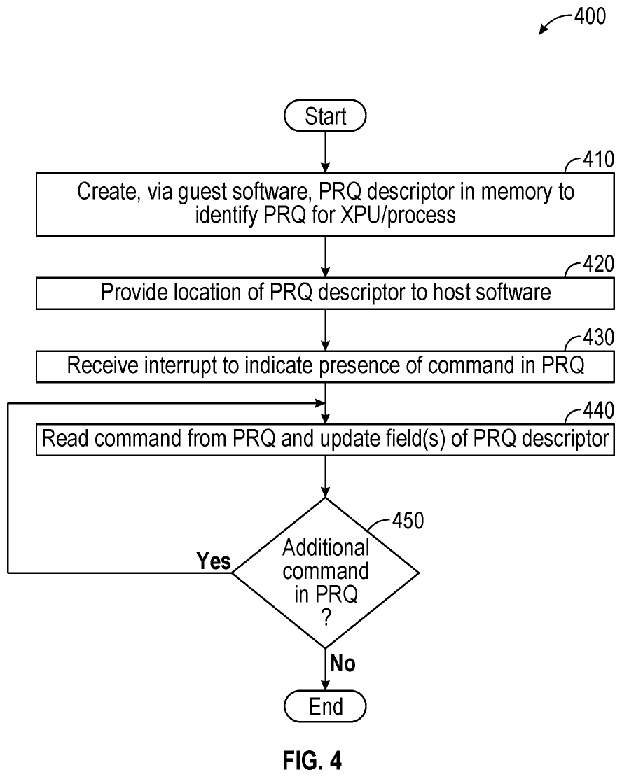

Referring now to FIG. 4, shown is a flow diagram of a method in accordance with an embodiment. More specifically, method 400 in FIG. 4 is a method performed by guest software in execution on one or more cores of a processor to enable an ATC to obtain guest process information from a data structure and use the information for directly informing the guest software of presence of commands from the ATC. As such, method 400 may be performed by guest software that executes on hardware circuitry such as one or more cores of a processor.

As illustrated, method 400 begins by creating a PRQ descriptor in memory (block 410). This PRQ descriptor may identify a location of a PRQ for a given XPU and process. That is, there may be multiple PRQs, where each PRQ is associated with a given XPU and process. As such, there can be as many PRQs for a given XPU as there are processes that execute on that XPU. In turn, there may be such multiple PRQs for each XPU of a system. Note that in an embodiment, this PRQ descriptor may be implemented in one or more fields of a PASID table stored in the memory.

Still with reference to FIG. 4, next at block 420, the location of this PRQ descriptor is provided to host software. Note that this provision may be by way of an indication of the address (namely a guest virtual address (GVA)). In response to this indication to host software, the host may add the corresponding PASID that is associated with the guest in the PASID table entry so that it may be sent along with a PRQ descriptor address to an XPU. These operations at blocks 410 and 420 thus enable the PRQ descriptor to be set up and be available to the ATC. Guest software may perform additional operations when a command is sent from an ATC. Specifically as shown in FIG. 4, at block 430, the guest software may receive an interrupt that indicates presence of a command in the PRQ.

Still with reference to FIG. 4, next at block 440, in response to this interrupt, the guest software reads a command from the PRQ. For purposes of discussion, assume that this command is a page fault request; of course, other commands may be received in other implementations. In response to this command, the guest software may determine whether to update page permissions associated with a memory page that is the subject of the page fault to indicate whether the ATC is allowed appropriate access to the page (e.g., read or write access). Also at block 440, the guest software may update one or more fields of the PRQ descriptor. For example, in response to this interrupt, the guest software may clear the PPR bit to indicate that the ATC needs to send an interrupt when it writes subsequent commands into the PRQ. Guest software then pulls out commands from the PRQ as located between the Head and Tail pointers and sends the commands to be processed. After this, the guest software waits for a next interrupt to restart this process. Although shown at this high level in the embodiment of FIG. 4, many variations and alternatives are possible.

Referring now to Table 2, shown is example pseudocode for guest software operation to handle a page request in response to receipt of an interrupt as described herein.

TABLE 2

```
Software read from PgReq
On receiving PRQ-interrupt:
Write PRQ_dsc_ppr(0);
Read PRQ_desc;
Max = PRQ_desc.size;
Tail = PRQ_desc.tail; Head = PRQ_desc.head;
While (Head != Tail) {
  read_PRQ (Head) // read from address = PRQ_desc.base +
  Head*command_size Head++;
  if (Head==Max) Head = 0; // wrap around
}
```

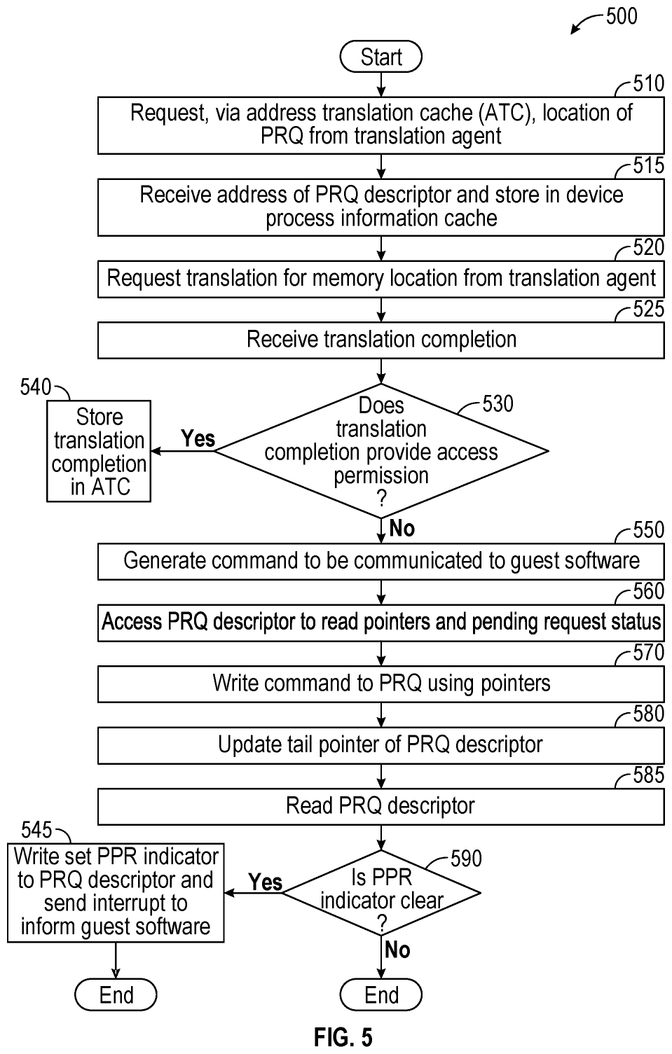

Referring now to FIG. 5, shown is a flow diagram of a method in accordance with another embodiment. More specifically, method 500 shown in FIG. 5 is a method to enable an ATC to directly communicate with various guest software instantiations via an architectural interface. As such, method 500 may be performed by an ATC of an XPU, e.g., using a cache controller or other hardware circuitry associated with the ATC.

As illustrated, method 500 begins with a request from the ATC for a location of a PRQ (block 510). Note that this request may be issued in response to a page fault or other indication that the ATC does not have access to a given memory location such as a page in a shared memory. This request is sent to a translation agent which in this case is an IOMMU. In response to this request, the ATC receives an address of a PRQ descriptor (block 515). Note that this PRQ descriptor is for a given XPU and process. On receipt of this PRQ descriptor address, the ATC stores it in a DevPIC.

Next at block 520, the ATC requests a translation for a given memory location from the translation agent (e.g., IOMMU). At block 525, the ATC receives a translation completion that may include a given address translation, namely, a translation to a physical address location associated with a given guest software to identify a memory location within a shared memory.

Still with reference to FIG. 5, next at diamond 530, it is determined whether the translation completion provides an access permission. If so, at block 540, the translation completion is stored in the ATC. Otherwise, control passes to block 550. At block 550, the ATC generates a command, e.g., a page fault request. Note that this page fault request may include an identification of a requested type of permission (e.g., read, write and/or read/write). Thereafter, at block 560, the ATC accesses the PRQ descriptor to read pointers and a PPR status. Here, the ATC reads head and tail pointers to identify a location at which the request is to be written. The PPR status, e.g., in the form of a PPR bit, indicates whether the ATC is to send an interrupt to inform guest software of the presence of this request.

Still with reference to FIG. 5, at block 570 the ATC writes the command to the PRQ using the pointers. Then at block 580 the ATC performs a write to the PRQ descriptor to update the tail pointer (e.g., by incrementing the value by one). Next at block 585, the PRQ descriptor (including the PPR bit) is again read.

Based on this read of the PPR bit in the PRQ descriptor at diamond 590, it is determined whether there is an outstanding PRQ interrupt towards guest software, e.g., as determined based upon the status of the PPR bit. More specifically, when set, this means that there is already at least one PRQ interrupt that has been sent to software but not yet serviced, so an additional interrupt does not need to be generated. In this case, no further operation occurs.

In the case that it is determined that there are no pending PRQ interrupts outstanding to software (indicated by a Clear PPR bit), control passes to block 595 where the ATC writes a set value to the PPR indicator in the PRQ descriptor and sends an interrupt to inform the guest software as to the presence of the page request. In an embodiment, this request may be sent to host software which in turn, provides the interrupt to the guest software. In other cases, this interrupt may be sent directly to the guest software. Understand while shown at this high level in the embodiment of FIG. 5, many variations and alternatives are possible.

Referring now to Table 3, shown is example pseudocode for ATC operation to write a command into a PRQ as described herein.

```
TABLE 3
ATC write into PgReq
Read PRQ_desc;
Tail = PRQ_desc.tail; Head = PRQ_desc.head; PPR =
PRQ_desc.ppr
While (Tail == (Head − 1)) { // PRQ is full so keep reading till some
space frees up read PRQ_desc;
  Tail = PRQ_desc.tail; Head = PRQ_desc.head; PPR =
  PRQ_desc.ppr
}
Write PgReq into PRQ (Tail);
Tail++
Write PRQ_dsc_tail(Tail);
// software may have changed PPR to 0
Read PRQ_desc.PPR;
PPR = PRQ_desc.PPR;
If (PPR == 0) {
  Write PRQ_dsc_ppr(1);
  generate PRQ_interrupt ;
}
```

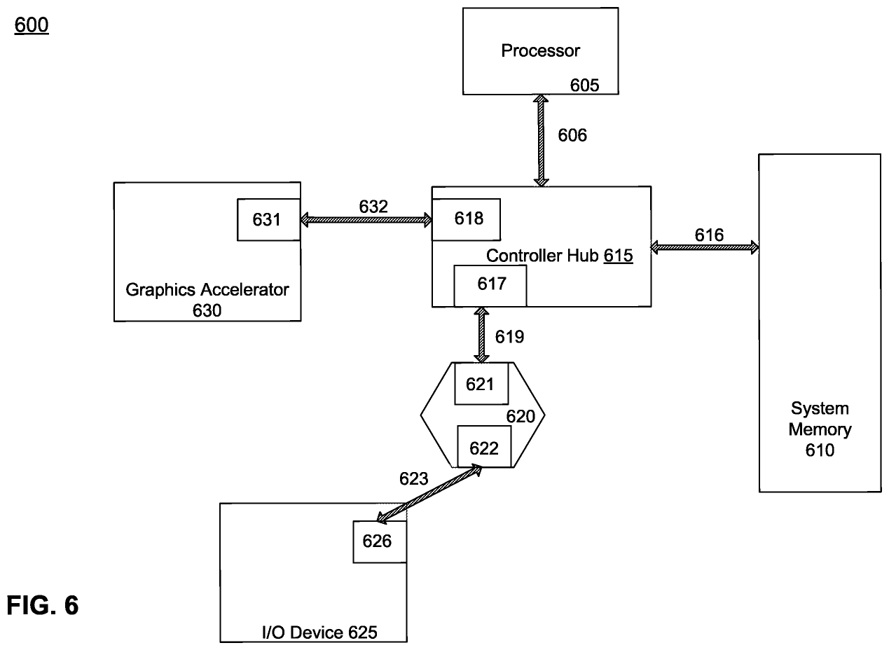

Embodiments may be implemented in a wide variety of interconnect structures. Referring to FIG. 6, an embodiment of a fabric composed of point-to-point links that interconnect a set of components is illustrated. System 600 includes processor 605 and a flash memory 610 coupled to controller hub 615. Processor 605 includes any processing element, such as a microprocessor, a host processor, an embedded processor, a co-processor, or other processor. Processor 605 is coupled to controller hub 615 through front-side bus (FSB) 606. In one embodiment, FSB 606 is a serial point-to-point interconnect.

System memory 610 includes any memory device, such as random access memory (RAM), non-volatile (NV) memory, or other memory accessible by devices in system 600.

As shown, system memory 610 is coupled to controller hub 615 through memory interface 616. Examples of a memory interface include a double-data rate (DDR) memory interface, a dual-channel DDR memory interface, a dynamic RAM (DRAM), and/or a SPI memory interface.

In one embodiment, controller hub 615 is a root hub, root complex, or root controller in a PCIe interconnection hierarchy. Examples of controller hub 615 include a chipset, a memory controller hub (MCH), a northbridge, an interconnect controller hub (ICH), a southbridge or peripheral controller hub (PCH), and a root controller/hub. Often the term chipset refers to two physically separate controller hubs, i.e. a memory controller hub (MCH) coupled to an interconnect controller hub (ICH). Note that current systems often include the MCH integrated with processor 605, while controller 615 is to communicate with I/O devices, in a similar manner as described below. In some embodiments, peer-to-peer routing is optionally supported through root complex 615. Root complex 615 may include an IOMMU that, in a SVM model, enables a graphics accelerator 630 and/or a device 625 (which may include ATCs in accordance with an embodiment) to access a common memory space with processor 605.

Controller hub 615 is coupled to switch/bridge 620 through serial link 619. Input/output modules 617 and 621, which may also be referred to as interfaces/ports 617 and 621, include/implement a layered protocol stack to provide communication between controller hub 615 and switch 620. In one embodiment, multiple devices are capable of being coupled to switch 620.

Switch/bridge 620 routes packets/messages from device 625 upstream, i.e., up a hierarchy towards a root complex, to controller hub 615 and downstream, i.e., down a hierarchy away from a root controller, from processor 605 or system memory 610 to device 625. Switch 620, in one embodiment, is referred to as a logical assembly of multiple virtual PCI-to-PCI bridge devices. Device 625 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such a device is referred to as an endpoint. Although not specifically shown, device 625 may include a PCIe to PCl/PCI-X bridge to support legacy or other version PCI devices. Endpoint devices in PCIe are often classified as legacy, PCIe, or root complex integrated endpoints.

Graphics accelerator 630 is also coupled to controller hub 615 through serial link 632. In one embodiment, graphics accelerator 630 is coupled to an MCH, which is coupled to an ICH. Switch 620, and accordingly I/O device 625, is then coupled to the ICH. I/O modules 631 and 618 are also to implement a layered protocol stack to communicate between graphics accelerator 630 and controller hub 615. A graphics controller or the graphics accelerator 630 itself may be integrated in processor 605.

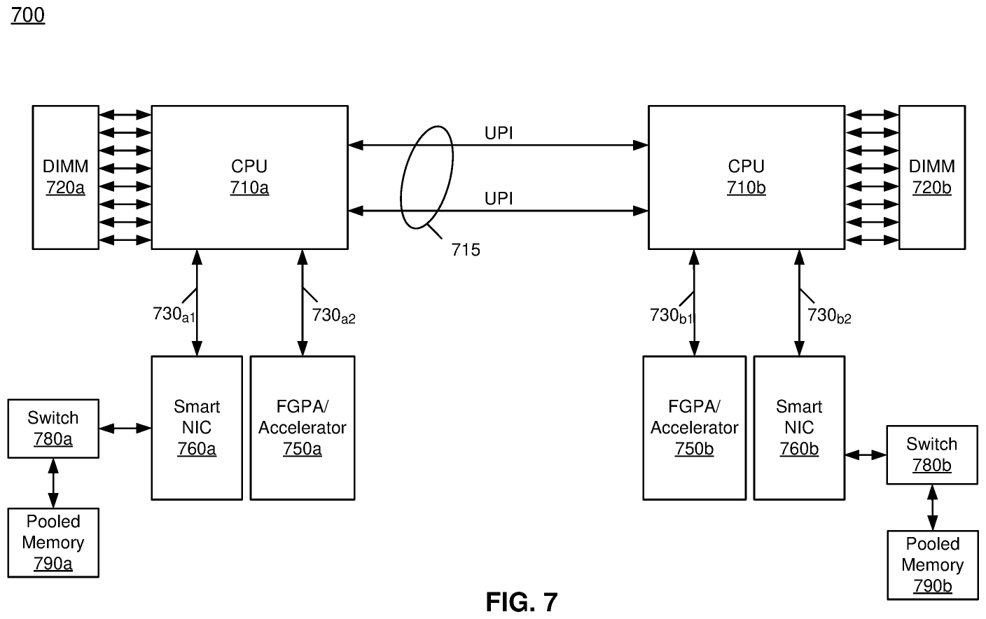

Referring now to FIG. 7, shown is a block diagram of a system in accordance with another embodiment. As shown in FIG. 7, a system 700 may be any type of computing device, and in one embodiment may be a server system. In the embodiment of FIG. 7, system 700 includes multiple CPUs 710a,b that in turn couple to respective system memories 720a,b which in embodiments may be implemented as DIMMs such as double data rate (DDR) memory, persistent or other types of memory. Note that CPUs 710 may couple together via an interconnect system 715 such as an Intel® Ultra Path Interconnect or other processor interconnect technology.

To enable coherent accelerator devices and/or smart adapter devices to couple to CPUs 710 by way of potentially multiple communication protocols, a plurality of interconnects 730a1-b2 may be present. In an embodiment, each interconnect 730 may be a given instance of a Compute Express Link (CXL) in which PCIe communications, including ATS communications may occur.

In the embodiment shown, respective CPUs 710 couple to corresponding field programmable gate arrays (FPGAs)/accelerator devices 750a,b (which may include GPUs or other accelerators may include ATCs in accordance with an embodiment). In addition CPUs 710 also couple to smart NIC devices 760a,b. In turn, smart NIC devices 760a,b couple to switches 780a,b that in turn couple to a pooled memory 790a,b such as a persistent memory. Of course, embodiments are not limited to accelerators 750 and the techniques and structures described herein may be implemented in other entities of a system.

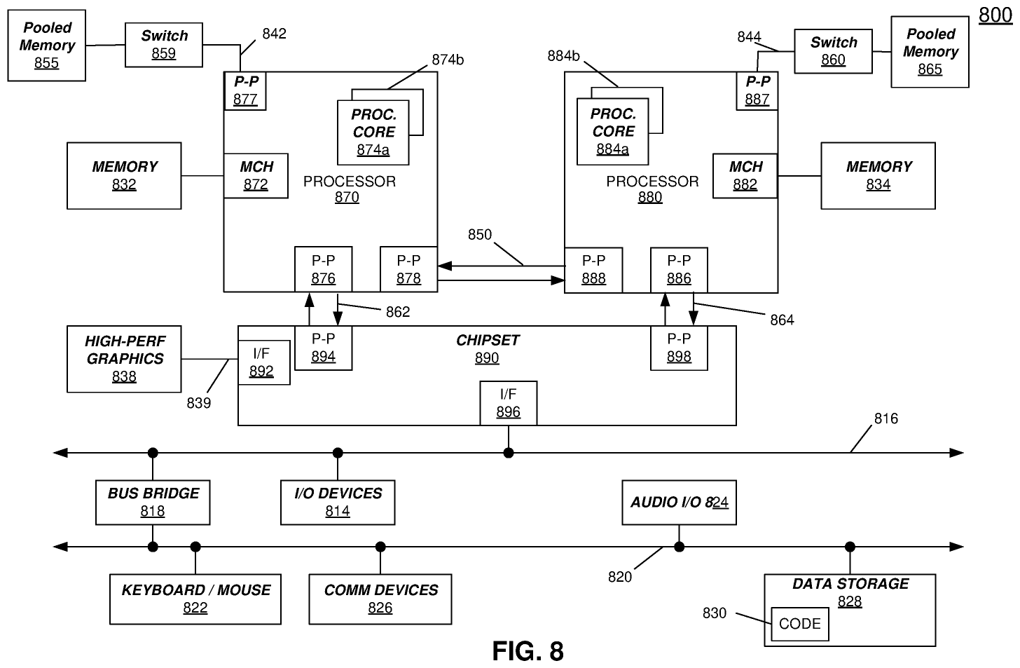

Referring now to FIG. 8, shown is a block diagram of a system in accordance with another embodiment such as a data center platform. As shown in FIG. 8, multiprocessor system 800 includes a first processor 870 and a second processor 880 coupled via a point-to-point interconnect 850. As shown in FIG. 8, each of processors 870 and 880 may be many core processors including representative first and second processor cores (i.e., processor cores 874a and 874b and processor cores 884a and 884b).

In the embodiment of FIG. 8, processors 870 and 880 further include point-to point interconnects 877 and 887, which couple via interconnects 842 and 844 (which may be CXL buses through which PCIe communications pass) to switches 859 and 860, which may include IOMMUs to enable devices having ATCs to access pooled memories 855 and 865.

Still referring to FIG. 8, first processor 870 further includes a memory controller hub (MCH) 872 and point-to-point (P-P) interfaces 876 and 878. Similarly, second processor 880 includes a MCH 882 and P-P interfaces 886 and 888. As shown in FIG. 8, MCH's 872 and 882 couple the processors to respective memories, namely a memory 832 and a memory 834, which may be portions of system memory (e.g., DRAM) locally attached to the respective processors. First processor 870 and second processor 880 may be coupled to a chipset 890 via P-P interconnects 876 and 886, respectively. As shown in FIG. 8, chipset 890 includes P-P interfaces 894 and 898.

Furthermore, chipset 890 includes an interface 892 to couple chipset 890 with a high performance graphics engine 838, by a P-P interconnect 839. As shown in FIG. 8, various input/output (I/O) devices 814 may be coupled to first bus 816, along with a bus bridge 818 which couples first bus 816 to a second bus 820. Various devices may be coupled to second bus 820 including, for example, a keyboard/mouse 822, communication devices 826 and a data storage unit 828 such as a disk drive or other mass storage device which may include code 830, in one embodiment. Further, an audio I/O 824 may be coupled to second bus 820.

The following examples pertain to further embodiments.

In one example, an apparatus comprises: at least one accelerator to perform operations on data; and an ATC coupled to the at least one accelerator, the ATC to store address translations. The ATC is to: send a command to a PRQ stored in a memory coupled to the apparatus, the PRQ associated with a process of a guest software; and send an interrupt to inform the process regarding the command.

In an example, the apparatus is to send the command to a location in the PRQ based on information in a PRQ descriptor stored in the memory, the PRQ descriptor associated with the process.

In an example, the apparatus is to send the command to the location in the PRQ based at least in part on a tail pointer of the PRQ descriptor.

In an example, the ATC is to send the interrupt when a pending request interrupt indicator of the PRQ descriptor indicates that there are no unserviced pending request interrupts.

In an example, the ATC is to: send a second command to the PRQ; and not send another interrupt to inform the process regarding the second command when a pending request interrupt indicator of the PRQ descriptor indicates that there is at least one pending request interrupt outstanding to guest software.

In an example, the apparatus is to send the command in response to an access permission violation to a location in the memory, the memory comprising a shared memory to be shared by the apparatus and a host processor on which the guest software is to execute.

In an example, the ATC is to receive a translation completion comprising a virtual address-to-physical address translation for the location in the memory, the translation completion to indicate the access permission violation.

In an example, the ATC is to: request an address of the PRQ from a translation agent; and in response, receive an address of a PRQ descriptor, the PRQ descriptor associated with the PRQ.

In an example, the apparatus further comprises a device process information cache, wherein the apparatus is to store the address of the PRQ descriptor in the device process information cache.

In another example, a method comprises: generating, in an ATC of an accelerator, a command to be communicated to a guest software in execution on a host processor coupled to the accelerator, the command for a memory location in a memory; accessing a PRQ descriptor to read pointer information and a pending request status, the PRQ descriptor associated with a PRQ of the memory, the PRQ associated with the accelerator and a process of the guest software; and writing the command to the PRQ using the pointer information.

In an example, the method further comprises sending an interrupt to inform the guest software regarding the command based at least in part on the pending request status.

In an example, the method further comprises sending the interrupt to a host software, the host software to provide the interrupt to the guest software.

In an example, the method further comprises: requesting, via the ATC, an address of the PRQ in the memory from a translation agent; and in response to requesting the address of the PRQ, receiving an address of the PRQ descriptor and storing the address of the PRQ descriptor in a device process information cache of the ATC, the PRQ descriptor associated with the accelerator and the process of the guest software and comprising the address of the PRQ.

In an example, the method further comprises storing, in the device process information cache, a plurality of PRQ descriptor addresses, each of the plurality of PRQ descriptor addresses associated with a process of the guest software.

In an example, the method further comprises receiving, from the translation agent, an address of the PRQ descriptor, the PRQ descriptor comprising a head pointer, a tail pointer, and a pending request status indicator.

In an example, the method further comprises generating the command in response to an access permission violation for the memory location in the memory.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system comprises: a memory; a CPU coupled to the memory, the CPU having at least one core to execute instructions, the CPU to execute a guest software; and a processing circuit coupled to the CPU, the processing circuit comprising: an accelerator to perform operations on data; and an address translation cache (ATC) coupled to the accelerator, the ATC to store address translations, wherein the ATC is to directly send a command to a process of the guest software via a PRQ stored in the memory, the PRQ associated with the process of the guest software.

In an example, the system further comprises a translation agent coupled to the processing circuit, the translation agent to send the ATC an address of a PRQ descriptor stored in the memory, the PRQ descriptor associated with the process.

In an example, the processing circuit further comprises a process information cache to store the address of the PRQ descriptor, the PRQ descriptor comprising an address of the PRQ and an indicator to indicate whether the ATC is to send an interrupt to inform the process of the command.

In an example, the memory is to store a PASID table, the PASID table to store a plurality of entries, at least one of which is associated with the process and to store the address of the PRQ descriptor.

Understand that various combinations of the above examples are possible.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
at least one accelerator to perform operations on data; and
an address translation cache (ATC) coupled to the at least one accelerator, the ATC to store address translations,
wherein the ATC is to:
send a command to a pending request queue (PRQ) stored in a memory coupled to the apparatus, the PRQ associated with a process of a guest software; and
send an interrupt to inform the process regarding the command.

2. The apparatus of claim 1, wherein the apparatus is to send the command to a location in the PRQ based on information in a PRQ descriptor stored in the memory, the PRQ descriptor associated with the process.

3. The apparatus of claim 2, wherein the apparatus is to send the command to the location in the PRQ based at least in part on a tail pointer of the PRQ descriptor.

4. The apparatus of claim 2, wherein the ATC is to send the interrupt when a pending request interrupt indicator of the PRQ descriptor indicates that there are no unserviced pending request interrupts.

5. The apparatus of claim 2, wherein the ATC is to:
send a second command to the PRQ; and
not send another interrupt to inform the process regarding the second command when a pending request interrupt indicator of the PRQ descriptor indicates that there is at least one pending request interrupt outstanding to guest software.

6. The apparatus of claim 2, wherein the apparatus is to send the command in response to an access permission violation to a location in the memory, the memory comprising a shared memory to be shared by the apparatus and a host processor on which the guest software is to execute.

7. The apparatus of claim 6, wherein the ATC is to receive a translation completion comprising a virtual address-to-physical address translation for the location in the memory, the translation completion to indicate the access permission violation.

8. The apparatus of claim 1, wherein the ATC is to:
request an address of the PRQ from a translation agent; and
in response, receive an address of a PRQ descriptor, the PRQ descriptor associated with the PRQ.

9. The apparatus of claim 8, wherein the apparatus further comprises a device process information cache, wherein the apparatus is to store the address of the PRQ descriptor in the device process information cache.

10. A method comprising:
generating, in an address translation cache (ATC) of an accelerator, a command to be communicated to a guest software in execution on a host processor coupled to the accelerator, the command for a memory location in a memory;
accessing a pending request queue (PRQ) descriptor to read pointer information and a pending request status, the PRQ descriptor associated with a PRQ of the memory, the PRQ associated with the accelerator and a process of the guest software; and
writing the command to the PRQ using the pointer information.

11. The method of claim 10, further comprising sending an interrupt to inform the guest software regarding the command based at least in part on the pending request status.

12. The method of claim 11, further comprising sending the interrupt to a host software, the host software to provide the interrupt to the guest software.

13. The method of claim 10, further comprising:
requesting, via the ATC, an address of the PRQ in the memory from a translation agent; and
in response to requesting the address of the PRQ, receiving an address of the PRQ descriptor and storing the address of the PRQ descriptor in a device process information cache of the ATC, the PRQ descriptor associated with the accelerator and the process of the guest software and comprising the address of the PRQ.

14. The method of claim 13, further comprising storing, in the device process information cache, a plurality of PRQ descriptor addresses, each of the plurality of PRQ descriptor addresses associated with a process of the guest software.

15. The method of claim 10, further comprising receiving, from the translation agent, an address of the PRQ descriptor, the PRQ descriptor comprising a head pointer, a tail pointer, and a pending request status indicator.

16. The method of claim 10, further comprising generating the command in response to an access permission violation for the memory location in the memory.

17. A system comprising:
a memory;
a central processing unit (CPU) coupled to the memory, the CPU having at least one core to execute instructions, the CPU to execute a guest software; and
a processing circuit coupled to the CPU, the processing circuit comprising:
an accelerator to perform operations on data; and
an address translation cache (ATC) coupled to the accelerator, the ATC to store address translations,
wherein the ATC is to directly send a command to a process of the guest software via a pending request queue (PRQ) stored in the memory, the PRQ associated with the process of the guest software.

18. The system of claim 17, further comprising a translation agent coupled to the processing circuit, the translation agent to send the ATC an address of a PRQ descriptor stored in the memory, the PRQ descriptor associated with the process.

19. The system of claim 18, wherein the processing circuit further comprises a process information cache to store the address of the PRQ descriptor, the PRQ descriptor comprising an address of the PRQ and an indicator to indicate whether the ATC is to send an interrupt to inform the process of the command.

20. The system of claim 17, wherein the memory is to store a process address space identifier (PASID) table, the PASID table to store a plurality of entries, at least one of which is associated with the process and to store the address of the PRQ descriptor.
